(19) United States
(12) Patent Application Publication
(10) Pub. No.: US 2004/0089975 A1
(43) Pub. Date: May 13, 2004

(54) Process for manufacturing components out of fibre-reinforced plastics

(76) Inventors: Robert Sala, Schaffhausen (CH); Markus Henne, Schaffhausen (CH)

Correspondence Address: BACHMAN & LAPOINTE, P.C., 900 CHAPEL STREET, SUITE 1201, NEW HAVEN, CT, 06510, US

(21) Appl. No.: 10/696,114

(22) Filed: Oct. 29, 2003

(30) Foreign Application Priority Data
Nov. 4, 2002 (EP) 02 405 945.3

(51) Int. Cl. B29C 45/14

(52) U.S. Cl. 264/257; 264/328.17; 425/550; 425/208

(57) ABSTRACT

A process for manufacturing fibre-reinforced plastic components whereby, a reactive starting mixture is prepared from a starting material and injected into a cavity in a mould containing a fibre-type mass, whereby the reactive molten mass along with the fibre-type mass is transformed by means of a polymeric reaction into a fibre-reinforced plastic component. A heated plasticising unit with screw feed system, prepares the starting material as a low viscosity, reactive molten mass, and the reactive molten mass is conveyed by the screw feed system from the plasticising unit and injected either directly or indirectly into the cavity of the mould.

### BACKGROUND OF THE INVENTION

The present invention relates to a process for manufacturing fibre-reinforced plastic components whereby, a reactive, low viscosity starting mixture which is capable of flow is prepared from a starting material and injected into a cavity of a mould containing a fibre-type mass, whereby the reactive starting mixture along with the fibre-type mass is transformed by means of a polymeric reaction into a fibre-reinforced plastic component. The invention also relates to a device for carrying out the process and the use of the fibre-reinforced plastic components.

Fibre-reinforced plastic components, hereinafter also called fibre-composite components, are gaining ever increasing importance in light-weight constructions because of their relatively low weight and, due to the presence of fibres in their structure, high strength. Fibre-composite components are also finding application as structure-bearing components in various fields, whereby such components often exhibit extremely complex, three-dimensional shapes.

As a rule the said fibre-composite components contain fibre structures which are in the form of large-area textile weaves. The production of such fibre-composite components is often conducted according to the following principle: Fibre masses of reinforcing fibres are laid in the cavity of a shape-giving mould. A reactive initial mixture is then injected into the closed mould, flowing all around the fibre mass and impregnating it. When the mould has been filled, the initial mixture is hardened to give a plastic matrix. The finished fibre-composite component is then removed from the mould.

The plastic matrix may be of a duroplastic or a thermoplastic material. In both cases an initial mixture has an activator added to it and is transformed into a low viscosity or ready-flowing reactive starting mixture. The starting materials are normally introduced into a container. The injection of the reactive starting mixture from the mixing container into the mould is carried out by means of pumps such as piston or rotary type pumps. The mixing container may e.g. be a mixing chamber in the head of an injection unit. If the starting materials are mixed by hand, then the mixing container may also be in the outlet of a pressure vessel.

A known method of manufacture is the so called Resin-Transfer-Moulding method (RTM method) as described e.g. in ,,Kotte, ‘Der Resin-Transfer-Molding-Prozess’, Publishers, TÜV Rheinland, 1991, pp 3-16“.

In the RTM process the cavity of an open, multi-part mould is charged with reinforcing fibres, in particular fibre-type masses, and if desired further components. In a subsequent step, a low viscosity reactive resin is injected into the cavity of the closed mould, forming a shaped fibre-composite. In a following step the shaped fibre-composite mass is hardened, whereby the starting mixture is transformed into a plastic matrix. The shape-stable fibre-composite component is subsequently removed from the mould.

The RTM process enables series production of fibre-composite composites of complex, three dimensional shape.

In the meantime not only duroplastic resins but also thermoplastics are processed using the RTM process, for which reason in the following, the expression “RTM process” stands for the process described above, regardless of the polymer system employed.

For some time now the interest in manufacturing fibre-composite components with thermoplastic matrix systems using the RTM process has increased greatly in importance. It is, for example, known to process poly(butyleneterephthalate)-(PBT)- or polyamide-(PA)-polymer systems into fibre-composite components using RTM processes.

The production of fibre-composite components with the RTM process is, however, very complex. This concerns in particular also the preparation of a starting mixture of low viscosity which is capable of reacting and the injection of the said mixture into the mould cavity.

The object of the present invention is to provide a simplified process and device for preparing a reactive starting mixture from a starting material and injecting the same into the cavity of a mould.

### SUMMARY OF THE INVENTION

The foregoing objective is achieved by way of the invention wherein the starting material is prepared in a plasticising unit with screw feed system under the application of heat to yield a low viscosity, reactive mixture and homogenised, and the starting mixture injected directly or indirectly into the cavity of a mould.

### BRIEF DESCRIPTION OF THE FIGURE

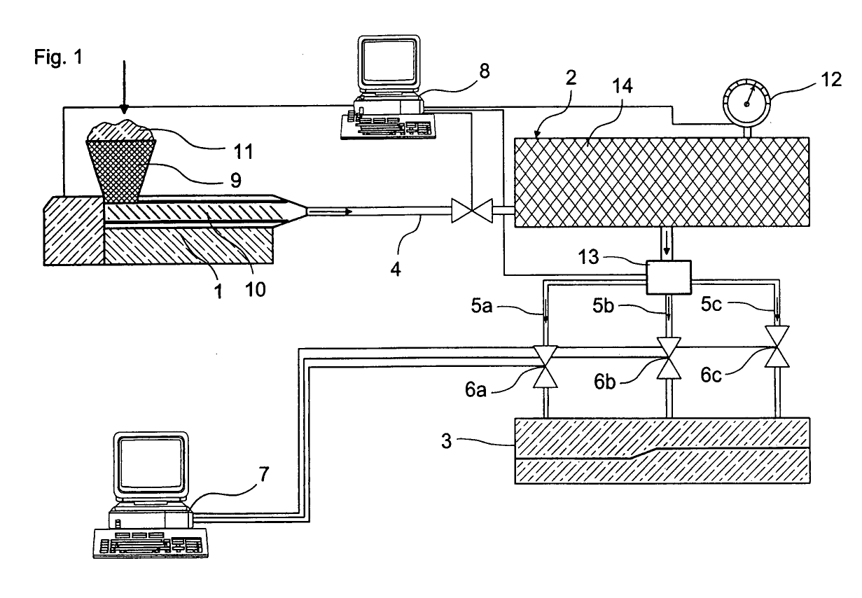

In the following the invention is described in greater detail by way of example and with reference to the accompanying FIG. 1 which shows in a schematic manner one version of a device according to the invention.

### DETAILED DESCRIPTION

By low viscosity, reactive starting mixture is to be understood the starting material in a fluid to pasty state which has not reacted. The starting material is transformed to a fluid-flow or molten state by supply of energy, in particular by supply of heat. By plastic matrix is to be understood the polymer resulting from polymerisation of the starting mixture.

The term plasticising means, in connection with plasticising unit, the transformation—in particular the melting and homogenisation—of non-reacted starting material into a reactive starting mixture of low viscosity. The plasticising unit is in a sense a mixing device.

Here the term pre-polymer should be a collective term e.g. for oligomers or partly also polymers that are already polymeric compounds, which are employed as pre-products or intermediate products i.e. as starting materials for manufacturing duroplastics or thermoplastics.

Polymeric reaction is to be understood here as the reactive conversion of starting materials in the form e.g. of monomers or pre-polymers or oligomers into thermoplastics or duroplastics. The overall term polymeric reaction includes e.g. also polymerisation.

The manufacturing process according to the invention is preferably an RTM pro-cess or a variant of the RTM process such as e.g. a TERTM (Thermal-Expanded-Resin-Transfer-Molding) or a VARTM (Vacuum-Assisted-Resin-Transfer-Molding) process.

The manufacturing process may however also e.g. be the object of a purely vacuum injection type process (e.g. VARI=“Vacuum Assisted Resin Infuision”) in which the reactive starting mixture flows through the fibres only under the influence of the applied vacuum, without support of pressure.

The rate of flow of the reactive starting mixture into the cavity is not an object of the present invention, with the result that on the basis of the mentioned flow rate, it is completely possible for the manufacturing process according to the invention to be closer to an RIM (Reaction-Injection-Molding) or S-RIM (Structural-Reaction-Injection-Molding) process.

The preparation of the low viscosity reactive starting mixture involves feeding a starting material via a co-ordinated filling unit to a plasticising unit in which, under the influence of energy input, preferably heat, the starting material is transformed to a starting mixture of low viscosity and using a screw system homogenised (thoroughly mixed). The starting mixture which is capable of flow can, with respect to viscosity, be fluid to pasty. The starting material may e.g. be softened or partly or completely molten.

The plasticising unit usefully contains energy supplying means. The energy supplied may, depending on the properties of the starting material, be electromagnetic radiation, microwaves, infra-red, ultraviolet or thermal radiation. The energy supply may also be in the form of thermal conduction.

In a preferred version the plasticising unit can be heated for the purpose of melting the starting material and maintaining an elevated temperature and fitted with means for heating. In a particularly preferred version of the invention the screw system is arranged in a cylinder that can be heated. Further, the plasticising unit may be equipped with thermal insulating means.

Also, the feeding facilities such as feed pipes or injection lines, or the transfer unit or parts thereof e.g. the reservoir or pumping unit may contain energy supply means described above. Here the means of supplying energy preferably serve the purpose of lowering the viscosity further and/or control or maintenance of the viscosity of the starting mixture. In a preferred version the means of supplying energy serve to heat or control the temperature of the starting material in the feed pipes or in the transfer unit. To this end the feed pipes or transfer unit preferably contain means for heating the same. The feed pipes or transfer unit may also be provided with thermal insulation.

It is possible that a plurality of plasticising units working in parallel are fed for the preparation of the starting mixture. The screw feed system serves the purpose of mixing and homogenising the starting material or starting mixture. Further, the screw feed system also preferably serves to transport the starting mixture out of the plasticising unit.

As mentioned above, between the plasticising unit or units and the mould is usefully a transfer unit which contains at least conveyance pipes or injection lines that connect the plasticising unit to the injection points in the mould. The injection lines may also run within the mould itself e.g. as injection channels joining up with the mould cavity.

The transfer unit may in some cases contain further components, including:

(a) a reservoir to accommodate the low viscosity starting mixture temporarily;

(b) a pumping unit working along with the injection line or lines in order to generate pressure for injection purposes;

(c) armatures for controlling the flow of material in the feed pipes or injection lines;

(d) means for controlling electronically the flow of material between the plasticising unit and mould and the form filling operation.

Further, the transfer unit itself or parts thereof may be arranged within the mould as an integral component.

The armatures may be e.g. valves, such as inlet or outlet valves, flaps or slides which if desired are controlled by sensors.

The starting material is preferably in the form of dry, preferably powder, granular, spherical or flake-shaped starting material. The starting material may also contain a mixture of several starting materials.

The starting material preferably contains pre-polymers, in particular oligomers, or monomers or a mixture thereof. Further, the starting material contains an activator which is solid or liquid at room for the purpose of initiating and/or accelerating the polymeric reaction. In a particularly preferred version the activator is already mixed into the starting material in the necessary amount and distribution. Also possible is for the activator e.g. in liquid form to be fed in specific amounts via a separate feed-ing system or to be mixed into the starting mixture after the plasticising unit.

By activator is meant usually a substance which is added in a small amount to start and/or accelerate the polymeric reaction. The term activator includes also accelerators and catalysts or accelerating catalysts.

The starting material may also contain further components such as filler materials, pigments (colorants), anti-oxidants, stabilisers, softeners or flame inhibiting substances.

In a specific version of the invention the plasticising unit may be part of an extruder or injection moulding system, whereby the starting mixture is fed from the plasticising unit into the mould directly via appropriate feed pipes or indirectly via a transfer device with reservoir.

In a first version of the invention the above mentioned plasticising unit is part of an extruder system. The low viscosity, reactive starting mixture is prepared by the screw system and transported in a continuous manner via at least one supply line from the plasticiser unit to the reservoir of a transfer unit. The extruder system may e.g. be a single screw extruder or a double screw extruder. The pressure for conveyance is thereby preferably provided by the screw system itself.

The starting material is then injected via one or more injection lines from the reservoir into the cavity of the mould. Provision made be made for the conveyance of the starting mixture from the extruder device to be interrupted temporarily within a production cycle, whereby the starting mixture is preferably held in a low viscosity state until the feeding process starts again.

The reservoir can be supplied with the starting mixture via one or more feed lines from one or more plasticising units.

The transfer unit preferably contains means for electronic control of the feed of reactive starting mixture to the mould as a function of the reservoir or the pressure prevailing at the injection points. This way the feeding of starting material into the mould can be controlled for each injection line in accordance with specific process parameters. Further, the feed of material via the individual injection lines can be regulated precisely at the start, during and at the end of the mould filling operation. To this end the injection lines leading into the mould preferably contain armatures that can be regulated electronically.

In a second version of the invention the plasticising unit is part of an injection moulding device. The related injection moulding process is a discontinuous or semi-continuous process which differs from the above extrusion device among other respects in that the starting mixture is prepared by means of a screw system, homogenised and fed to a control feed space situated in front of the screw tip. The control feed space may be a preliminary chamber situated in front of the screw or a pre-screw space formed by drawing the screw back. The measured feed of starting mixture is then injected into the cavity of the mould directly via supply lines or via a transfer device with reservoir. The pressure for injection is preferably created by a piston acting on the starting mixture that has accumulated in the controlled feed space. In that connection the screw itself may act as the piston in that it moves forward along its axis in the direction of the control feed space and produces a pressure for injection purposes.

In all versions of the invention provision may be made for the starting mixture in the plasticising unit to have a higher viscosity than the starting mixture injected into the mould. The starting mixture may e.g. be fed in a liquid to pasty or soft state from the plasticising unit or from the screw system to the exit opening of the plasticising unit. The viscosity of the starting mixture is lowered, in particular by heating, on leaving or after leaving the plasticising unit, in order that the starting mixture can be injected into the mould as a low viscosity liquid or molten mass. The lowering of the viscosity may take place e.g. at the outlet opening or outlet nozzle of the plasticising unit, in the pipelines, in particular in the feed pipes and/or injection lines, in particular parts of the plasticising unit such e.g. in the reservoir or in the pump unit. Further, the reduction of viscosity may take place just prior to entry to the mould or in the mould itself before entering the cavity. It is self evident that the viscosity of the starting mixture, can be lowered continuously or in steps to a particular value on passing through the above mentioned individual elements situated after the plasticising unit until reaching the cavity.

As the mentioned lowering of the viscosity effects corresponding changes in the pressure conditions within the system, means for regulating and measuring the pressure conditions within the plasticising unit, the supply lines and further parts of the transfer unit may be foreseen. The mentioned means may in particular be armatures for controlling the flow of material to various points.

In a preferred version of the invention the mould is held at a temperature different from that of the plasticising unit and if desired that of the transfer unit. To that end means for thermally decoupling the mould from the transfer unit or parts thereof and/or the plasticising unit are foreseen between the mould and the plasticising unit or the transfer unit or parts of the transfer unit. The said means are preferably provided on the injection supply lines, in particular on the armatures of the injection supply lines.

In a preferred version of the invention the plastic matrix of the fibre-composite component is a thermoplastic such as polyamide-12 (PA12) or polybutylenetherphthalate (PBT).

The related starting materials preferably contain pre-polymers, in particular oligomers or monomers.

In a preferred version of the invention thermoplastic polymer systems are employed, the starting materials for which exhibit a lower temperature of melting or softening temperature than the polymerised plastic matrix and its ideal reaction temperature lies above the melting or softening temperature of the starting material and below the melting temperature of the polymer product (plastic matrix).

By ideal reaction temperature is to be understood here that temperature at which the reaction rate and the supply of energy to reach this reaction rate are optimised with respect to each other i.e. at which for the smallest supply of energy a maximum reaction rate which is still economic for the process is achieved.

The temperature of the plasticising unit lies preferably in the region of the melting point of the starting material (Edukt). The temperature of the transfer unit lies preferably above the temperature of melting of the starting material, so that the starting mixture is in a low viscosity, molten state. As the reaction rate is dependant on temperature i.e. increases with increasing temperature of starting material, the temperature of the starting mixture in the transfer unit should be kept so low that the lowest possible viscosity in the starting mixture is achieved for the lowest possible reaction rates. Also, it should be possible to keep the starting mixture in a reservoir for a specific time without it reacting to form a polymer prematurely.

This prevents premature reaction of the reactive starting mixture—present as a molten mass—which would lead to a marked increase in the viscosity. The temperature of the mould itself lies close to the ideal reaction temperature so that, when the filling of the mould has been completed, the starting mixture reacts as fast as possible and solidifies. This requires, however, as mentioned above, the mould to be uncoupled thermally from the transfer unit or from the plasticising unit.

The plastic matrix of the fibre-composite component created from the starting mixture is, by way of special preference, a poly(butyleneterephthalate) (PBT). The starting material for manufacturing the PBT-plastic matrix contains e.g. cyclic oligomers of CPBT which are mixed with a catalyst, in particular a zinc catalyst. Particularly suitable cyclic oligomers are available from the Company Cyclics under the trade name CBT™. The choice of catalyst which is mixed into the pre-polymer depends on the reactivity aimed for in the starting mixture. The various catalysts that can be employed (not described further here) cover a broad spectrum of reactivity, and this choice has ultimately a decisive influence on the production rate of the process.

The said starting material may contain further suitable additives, as described above.

The starting material of the above mentioned cyclic oligomers introduced into the plasticising unit as dry constituent is preferably heated to a temperature in the region of melting, is partly or completely melted and homogenised. After supplying further energy (e.g. heating), the starting material is then transformed to a reactive starting mixture of low viscosity.

Before injection into the mould the starting material is preferably heated to a temperature of 160° C. to 180° C. The viscosity of the molten mass is still around 150 mPa*s while the plastic mass is at a temperature of 160° C., whereas at a temperature of around 180° C. this lies at only 17 mPa*s. The molten mass is held at a preferably constant temperature in the region of 160 to 190° C. until the polymeric reaction or polymerisation has started.

The molten mass is injected either directly or indirectly via a transfer unit with reservoir through one or more injection lines into the heated mould. In the said mould the molten mass is heated to the ideal reaction temperature of around 180 to 200° C. at which the molten mass is polymerised to PBT. As the PBT has a melting temperature of around 225° C.—significantly above the ideal reaction temperature—the plastic matrix solidifies to a fibre-composite component as the polymeric reaction progresses.

As the temperature of the mould lies in reactive temperature range of the molten mass of around 180 to 200° C., and is therefore lower than the temperature of melting of the polymerised plastic matrix of 220 to 230° C., the mould can be held at the same temperature during all production cycles, i.e. it is not necessary to follow any temperature cycles.

The mould is usefully made up of a closable, multi-part, preferably two-part mould with at least two parts or halves that form a cavity.

Usefully means for heating and/or cooling the mould are provided. The said means may e.g. comprise heating and/or cooling channels in the mould.

In order to carry out the process at the start of the production cycle a fibre mass is inserted in the mould; this represents so-called charging of the mould.

The reactive starting mixture is, as described above in detail, subsequently injected into the cavity of the closed mould, whereby the starting mixture wets and envelops the fibre mass. After the mould has been filled, the starting mixture is transformed by polymeric reaction to a plastic matrix.

When the plastic matrix has solidified sufficiently, the finished fibre-composite component is removed from the mould. The mould is then prepared for a new production cycle. The time require for one single cycle depends—as described above—essentially on the rate of injection, the rate of the polymeric reaction and crystallisation of the starting mixture which in turn can be determined by the choice of activator.

The fibre mass inserts may be in the form of textile meshes e.g. fleeces, non-wovens, non-mesh type systems such as weaves, unidirectional or bi-directional layers, interwoven materials or mats or net-like structures such as knits or textiles and sewn structures. The fibres employed are preferably long fibres with fibre lengths of e.g. 3-150 mm or endless fibres. The fibre mass laid in the mould may also be single or multi-part.

A preferred version of fibre-composite components makes use of large area textile-type meshes of oriented fibres and in particular textile meshes of preferably long fibres or endless fibres.

The fibre masses may e.g. be in the form of a pre-form shaped to fit the contour of the fibre-composite component or mould. Further, the fibre mass may be impregnated with a binder. The binder improves the cohesion of the fibre structure, increases the formability and the stability of shape of the fibre mass and serves to prevent occlusion of gas between the fibres on injecting the starting mixture into the mould. The binder may e.g. be of the same material as that to form the plastic matrix.

Fibre semi-finished products may be manufactured from glass fibres, carbon fibres, Aramide fibres or mixtures thereof. Further types of fibre made from plastic or natural fibres may also be employed.

The present invention exhibits the advantage that the preparation of the starting mixture can be carried out using conventional, commercially available plasticising units as are employed e.g. in extruder or injection moulding equipment. In some cases the mentioned plasticising units may have to be modified, but only slightly. The use of such plasticising units is possible because the melting point of the starting mixture lies significantly below its polymeric reaction temperature. Consequently, the starting mixture can be passed through the plasticising unit without the polymeric and crystallisation process starting.

The fibre-reinforced plastic components manufactured by the process according to the invention find application e.g. in road and rail vehicles, in air transport and aerospace applications, in ship and boat construction, in building technology, in particular in light-weight construction e.g. for reinforcing building constructions or in sports equipment.

The highly preferred fibre-composite components with a thermoplastic matrix exhibit decisive advantages over those with a duroplastic matrix. Components with a thermoplastic matrix can be joined at will to each other or to other components by thermoplastic welding or thermoplastic adhesive bonding. In addition the said components can be shape formed and straightened at will, Further, there are advantages over the epoxy-resin systems known to date with respect to recycling and impact toughness.

With reference to FIG. 1, an extruder device 1 has a starting material 11 e.g. in granulate or powder form fed to it via a filling unit 9. The starting material 11 which may be a mixture of substances comprising several components such as e.g. oligomers, catalysts, filler materials etc. is prepared in the heated extruder device 1 to a low viscous, reactive molten mass which is homogenised by means of at least one extruder screw 10 and transported into the reservoir 14 of a transfer unit 2. The pressure for transportation is created by the extruder screw 10 itself.

The reactive molten mass is injected, by means of a pump unit 13 from the reservoir 14 via injection feed lines 5a, 5b, 5c, into the cavity of a mould 3 which contains the fibre mass. When using multiple injection feed lines, one speaks of so-called “Multi-Gate-Injection”. The flow of material through the injection feed lines 5a, 5b, 5c is regulated by valves 6a, 6b, 6c. The valves and the pump unit 13 are electronically controlled with the support of computers 7. As a result of valve control, the flow of material can be regulated precisely via the individual injection feed lines at the start, during and at the end of the mould-filling process.

Further, the amount of reactive molten mass fed from the extrusion device is also regulated by computer 8 as a function of the pressure 12 prevailing in the reservoir 14 of the transfer unit 2.

1. A Process for manufacturing a fibre-reinforced plastic component comprises:
providing a starting material;
preparing a starting mixture from the starting material, wherein the starting material is processed in a plasticising unit having a screw feed system under the application of heat to yield a low viscosity, homogenized, reactive starting mixture; and
injecting the reactive starting mixture into a cavity of a mold containing a fibre mass, wherein the reactive starting mixture along with the fibre mass is transformed by means of polymeric reaction into the fibre-reinformed plastic component.

2. A process according to claim 1, wherein the plasticising unit is part of an extruder device, and the homogenised, reactive starting mixture is conveyed from the plasticising unit by means of the screw system.

3. A process according to claim 2, wherein the starting mixture is conveyed via a supply line from the plasticising unit into a reservoir of a transfer unit and is injected by means of a pump unit via at least one injection feed pipe from the reservoir into the cavity of the mould.

4. A process according to claim 1, wherein the plasticising unit is part of an injection moulding device, and the homogenised, reactive mixture is conveyed by means of a screw system into a measured feed space situated in front of the screw system and conveyed by means of pistons from the measured feed space of the plasticising unit.

5. A process according to claim 4, wherein the starting mixture is injected from the measured feed space of the plasticising unit by at least one injection feed pipe into the cavity of the mould by means of a piston.

6. A process according to claim 4, wherein the starting mixture is conveyed via a supply line from the plasticising unit into a reservoir of a transfer unit and is injected by at least one injection feed pipe from the reservoir into the cavity of the mould.

7. A process according to one of the claims 1 to 6, wherein the starting mixture in the plasticising unit exhibits a fluid to pasty consistency and the viscosity of the starting mixture on leaving the plasticising unit until it enters the cavity of the mould is reduced further by input of energy until it reaches a fluid to highly fluid consistency.

8. A process according to claim 7, wherein the step in which the starting mixture is injected into the mould is regulated electronically by means of one of armatures and valves.

9. A process according to claim 8, wherein an injection feed pipes proximate to the related armatures or valves, comprises means to decouple the mould thermally from a transfer unit and from a plasticising unit.

10. A process according to claim 7, wherein the starting material is in the form of a dry solid material selected from the group consisting of powder, granulate, spherical, flake and mixtures thereof.

11. A process according to claim 7, wherein the starting material comprises pre-polymers mixed with an activator which accelerates the polymeric reaction.

12. A process according to claim 1, wherein the plastic matrix produced from the reactive starting material is one of a plastic in the form of a thermoplastic and duroplastic.

13. A process according to claim 1, wherein the plastic matrix produced from the reactive starting mixture is a poly(butyleneterephthalate) (PBT), and contains cyclic oligomers of the PBT (CPBT) mixed with a zinc catalyst.

14. A process according to claim 1, wherein the starting mixture contains pre-polymers mixed with an activator for polymeric reaction with the pre-polymers, and the melting temperature of the starting mixture is lower than the melting temperature of the plastic component produced from the starting mixture and the ideal reaction temperature for the starting mixture is higher than the melting temperature of the starting mixture and lower than the melting temperature of the plastic matrix.

15. A device for carrying out the process according to claim 1, comprises means for preparing and mixing the starting material, the means comprise a plasticising unit with screw feed system for preparing and homogenising the low viscosity, reactive starting mixture, and means for supplying energy to the starting material are provided in the plasticising unit.

16. A device according to claim 15, wherein the plasticising unit is part of an extruder device.

17. A device according to claim 15, wherein the plasticising unit is part of an injection moulding unit.

18. A device according to one of the claims 15 to 17, wherein the device contains a transfer unit with a reservoir, and the plasticising unit is connected via one or more feed pipes to the reservoir of the transfer unit, and the reservoir is connected via one or more injection feed pipes to the cavity of a mould.

19. A device according to claim 18, wherein the mould is thermally decoupled from the plasticising unit and the transfer unit.

20. A device according to claim 18, wherein the transfer unit includes means for supplying energy for heating.

21. A device according to claim 18, wherein the transfer unit is arranged outside the mould.

22. A device according to claim 18, wherein the transfer unit is arranged inside the mould.
